(19) United States
(12) Patent Application Publication
(10) Pub. No.: US 2007/0190818 A1
(43) Pub. Date: Aug. 16, 2007

(54) PACKAGE WITH APERTURE

(76) Inventor: Frank Barassi, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/553,539

(22) Filed: Oct. 27, 2006

(30) Foreign Application Priority Data
Oct. 31, 2005 (CA) 2,524,930

(51) Int. Cl. H01R 12/00

(52) U.S. Cl. 439/69

(57) ABSTRACT

This invention relates to a package adapted to contain an electronic device. The package comprises at least one aperture. The aperture is generally aligned with the socket of the electronic device. It is thus possible to program or reprogram the electronic device and/or to recharge a battery directly inside the package without opening it. A method to use the package is also provide therewith.

### CROSS-REFERENCE TO RELATED APPLICATIONS

There is not cross-related application.

### FIELD OF THE INVENTION

This invention relates to commodity packages. More particularly, this invention relates to a package having an aperture.

### BACKGROUND OF THE INVENTION

Nowadays, with the explosion of the globalization, quantities of merchandises and other commodities are shipped everyday around the world. All these merchandises are usually packed in boxes of different types and different sizes.

It is of no surprise that electronic devices are also packed in boxes, usually made of paperboard or cardboard. Some of these packages comprise windows, sometimes covered with a transparent film or sheet, that allow the potential customer to see part of the product without opening the package.

These packages have served us well with respect for their designed use. However, numerous electronic device available on the market today are programmable and/or are battery operated. Indeed, electronic devices containing programmable electronic chips are countless today. However, with the current technology, these devices are either programmed before being packaged or programmed once the device has been extracted from its package. Hence, there is no way to program an electronic device directly in its package.

In a world of just-in-time inventories, it would be desirable to provide a package which allow the distributors and/or vendors to program or even reprogram the device inside the package without opening it. Thus, they could receive prepackaged blank devices which would be program on-site, before being shipped or even during the sale. This would also insure that the most recent version of the program is installed at the time of the sale. Also, such a package would allow rechargeable batteries contained in the device to be recharge prior to being sold.

### OBJECTS OF THE INVENTION

Accordingly, an object of the present invention is to provide a package which allows the electronic device located inside to be programmed and/or recharged without opening the package.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention, there is provided a package with at least one aperture.

The package of the present invention comprises a plurality of walls, which, when fully assembled, defined a generally prismatic box or enclosure.

One of the walls of the package further comprises at least one opening or aperture.

According to the present invention, an electronic device, preferably programmable and/or rechargeable and comprising a socket, is inserted inside the package. The socket of the device is generally aligned with the aperture. By connecting a plug to the socket through the aperture, the plug being operatively connected to a programming and/or recharging device, it is possible to program and/or recharge the device inside the package without opening or tampering it. It is to be understood that the size and shape of the aperture are generally similar to the size and shape of the socket. Slightly larger apertures may be preferable since they would generally compensate for some movements of the device inside the package. Generally smaller apertures are to be avoided since they would hinder to connection between the plug and the socket.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE DRAWINGS

FIG. 1 is a perspective view an embodiment of the package of the present invention.

FIG. 2 is a top view of a plurality of packages.

### DETAILED DESCRIPTION OF THE PREFERRED EMBODIMENT

The present invention relates to a package for electronic devices and more particularly to such devices which are programmable and/or battery operated.

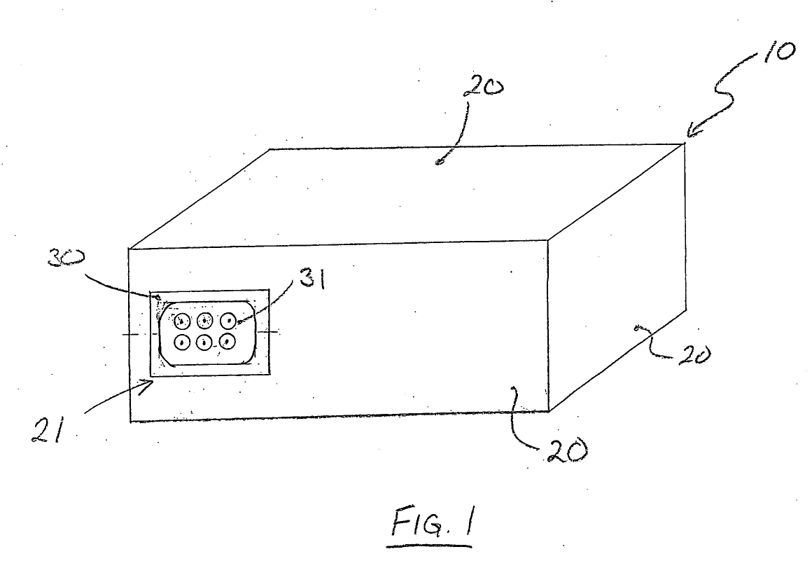

Referring to FIG. 1, a preferred embodiment of the package 10 of the present invention is shown. The package 10 is preferably made out of paperboard or cardboard but other package materials such as plastic could be contemplated.

The package 10 comprises a plurality of walls 20 which, when fully assembled, define a generally prismatic hollow box. One of the walls 20 further comprises an aperture or opening 21. An electronic device 30, located inside the box 10, comprises a socket 31 which is adapted to receive a plug (not shown) operatively connected to another electronic device such an electronic programmation unit, a computer, a handheld device, a power supply, a battery charger and the like (not shown). The socket 31 must be generally aligned with the aperture 21 in order for the socket 31 to be accessible without opening the package 10. The skilled addressee will understand that the size and shape of the aperture 21 must generally match the size and shape of the socket 31 in order for the plug to easily access the socket 31. Larger aperture 21 might be preferable in some cases to compensate for some movements of the device 30 during the handling of the package.

In a preferred embodiment of the present invention, the package 10 is made of paperboard or cardboard and the electronic device 30 is a programmable transponder module for cars. In the preferred embodiment, the device 30, which comprises an electronically programmable component (EEPROM, flash memory and the like), is manufactured blank. In other words, the device 30 is completely manufactured but the programmable components are left empty. The device 30 is then packaged into the package 10 and sent to distributors and vendors.

If a distributor receives an order for a certain quantity of devices 30 for a specific model of car, the distributor programs each device 30 according to the specific model of car without opening the package 10. He or she can connect the plug of the programming device directly to the socket 31 of the device 30 through the aperture 21. The packages 10 are thus untampered.

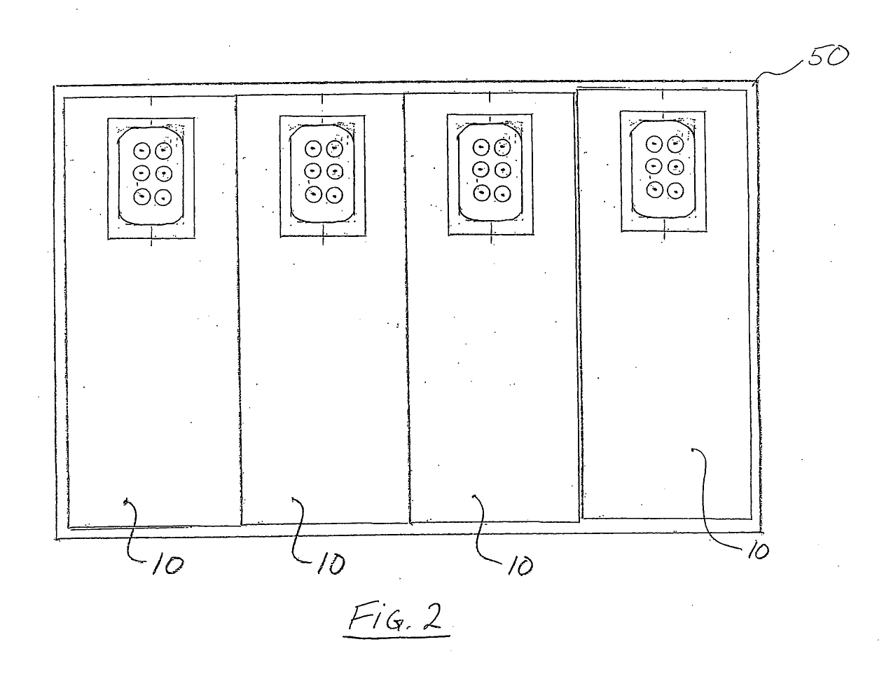

If the packages 10 come in a larger shipping box or similar larger enclosure 50, as shown in FIG. 2, it is possible to program multiple devices 30 at the same time, thus significantly saving on the programming time. The use of an adapted programming device is however required.

In order to fully use the present invention, one must first provide a package 10 comprising a plurality of walls 20. One of the walls 20 must have an aperture 21. Then, after providing an electronic device 30 with a socket 31, the device 30 is inserted into the package 10. Finally, the socket 31 of the device 30 is aligned with the aperture 21 of the package 10.

Even though the present invention has been described in relation to a programmable electronic device, it is to be understood that other uses are to be contemplated. For example, instead of being used to program the device 30, the aperture 21 and the socket 31 might be used to recharge the batteries (not shown) of the device 30. Indeed, the socket 31, operatively connected to the device's batteries, might be adapted to receive the plug of a power supply. It could thus be possible to recharge the batteries of the device 30 prior to selling it.

Although preferred embodiments of the invention have been described in detail herein and illustrated in the accompanying figures, it is to be understood that the invention is not limited to these precise embodiments and that various changes and modifications may be effected therein without departing from the scope or spirit of the present invention.

1. A package for use with an electronic device comprising at least one socket, said package comprising a plurality of walls which define an enclosure into which said electronic device can be received, wherein one of said walls further comprises an opening whereby when said electronic device is received inside said package, said at least one socket is substantially aligned with said opening.

2. A package as claimed in claim 1, wherein said package is made of paperboard or of cardboard.

3. A package and electronic device assembly, said assembly comprising:
a. an electronic device itself comprising a socket;
b. a package, said package comprising a plurality of walls, said walls defining an enclosure;
wherein one of said walls further comprises an opening and wherein said socket of said device is generally aligned with said opening for accessing said socket thereto.

4. An assembly as claimed in claim 3, wherein said electronic device comprises a battery and wherein said socket is operatively connected to said battery.

5. An assembly as claimed in claim 3, wherein said electronic device comprises a programmable electronic element and wherein said socket is operatively connected to said programmable electronic element.

6. An assembly as claimed in claim 3, wherein said electronic device is programmable transponder.

7. A method for providing a package and electronic device assembly comprising the steps of:
a. providing a package having a plurality of walls defining an enclosure, one of said walls further comprising an opening;
b. providing a electronic device which comprises at least one socket;
c. inserting said device in said package;
d. aligning said socket with said opening.

8. A method of programming a programmable electronic device having a program socket, said method comprising the steps of:
a. providing a package having a window;
b. inserting said electronic device in said package;
c. aligning said socket with said window;
d. connecting a programming device to said socket through said window;
e. programming said device.
